(19) United States
(12) Patent Application Publication
(10) Pub. No.: US 2003/0185480 A1
(43) Pub. Date: Oct. 2, 2003

(54) Device package with reduced bonding stresses

(76) Inventors: Antao Chen, Allentown, PA (US); William E. Derbyshire, Lehigh Township, PA (US)

Correspondence Address: Lester H. Birnbaum, 6308 Sauterne Drive, Macungie, PA, 18062, US

(21) Appl. No.: 10/108,794

(22) Filed: Mar. 28, 2002

(51) Int. Cl. G02F 1/01; G02B 6/27; G02B 6/00

(52) U.S. Cl. 385/1; 385/11; 385/147

(57) ABSTRACT

A device package and method of fabrication where the device is bonded to the package housing using a bonding medium. The medium includes a solid compliant material, preferably with pressure sensitive adhesive layers formed on the major surfaces. The bonding medium results in reduced stresses on the device, and is especially suitable for photo-elastic devices such as lithium niobate optical devices.

### FIELD OF THE INVENTION

The present invention relates generally to device packages and, more particularly, to a device package and method of fabrication which reduces stresses on the optical circuit chip of the package.

### BACKGROUND OF THE INVENTION

Optoelectronics devices and packaging have become increasingly important for modem communications. As speeds have increased, control of device parameters has presented a major challenge.

For example, Polarization Mode Dispersion (PMD) is a major barrier to achieving greater than 10 Gbit/s transmission over long distances. In order to alleviate this problem, it has been proposed to provide a polarization controller which includes a lithium niobate substrate with a series of optical wave plates formed thereon. (See, eg, U.S. Pat. No. 5,212,743.) In order to function optimally, it is desirable that the dc voltages to the electrodes of the wave plates vary no more than 5 volts, and preferably no more than 2 volt.

A common approach to fabricating a packaged polarization controller is to bond the lithium niobate substrate to a Kovar or other metal or plastic housing using a liquid epoxy. Unfortunately, when the epoxy is cured, stresses can be induced in the substrate. This often results in a voltage distribution across the wave plates as high as 12 volts.

It is desirable, therefore to produce a device package with reduced stresses on the device.

### SUMMARY OF THE INVENTION

To achieve these and other objects, and in view of its purposes, the present invention provides, in accordance with one aspect, a device package including a housing and a photo-elastic device mounted within the housing. A bonding medium is provided between the device and the housing. The bonding medium comprises a solid compliant material.

In accordance with another aspect, the invention is a method of fabricating a device package which includes the steps of bonding a photo-elastic device to a housing by providing therebetween a bonding medium comprising a solid compliant material, and providing pressure to the device so that the device adheres to the housing.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that the various features of the drawing are not to scale. On the contrary, the dimensions of the various features are arbitrarily expanded or reduced for clarity. Included in the drawing are the following figures:

FIG. 1 is a perspective view of a typical device that may be packaged in accordance with an embodiment of the invention;

FIG. 2 is a an exploded perspective view of a package including the device of FIG. 1 in accordance with an embodiment of the invention;

FIG. 3 is an enlarged view of a portion of the package illustrated in FIG. 2 FIG. 4 is an end view of a bonding medium in accordance with an embodiment of the invention; and

FIG. 5 is a cross sectional view taken along line 5-5 of FIG. 3.

### DETAILED DESCRIPTION OF THE INVENTION

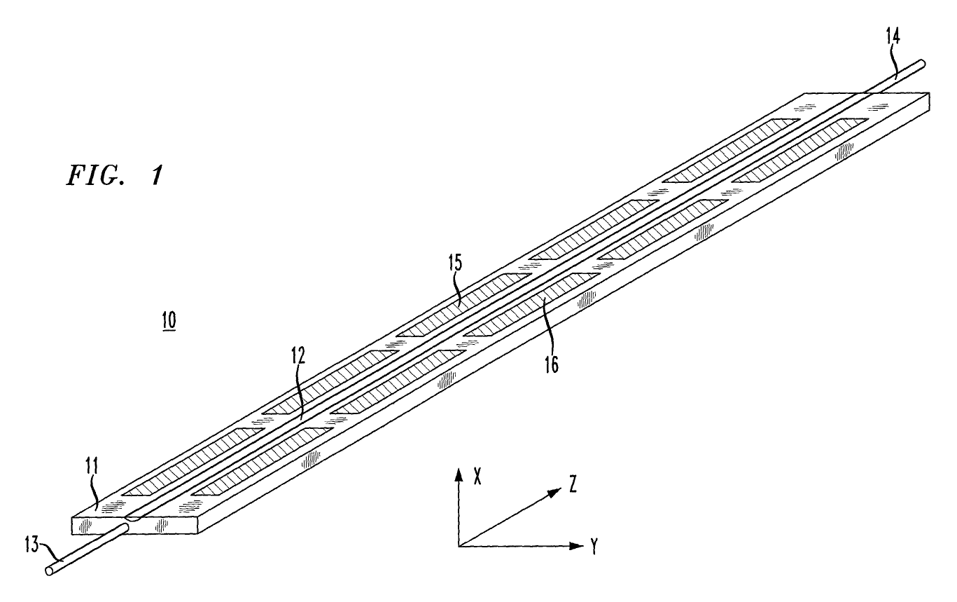

Referring now to the drawing, wherein like reference numerals refer to like elements throughout, FIG. 1 is a device, 10, which can be packaged in accordance with an embodiment of the invention. The particular device shown is a polarization controller that includes an electro-optic substrate, 11 (ie, a material whose index of refraction will change in response to an applied bias). In this example, the substrate is lithium niobate, but other materials such as lithium tantalate, gallium arsenate, and indium phosphate could perform similar functions. A waveguide, 12, typically formed by diffusion of titanium in the substrate, provides a light path through the device from an input fiber, 13 to an output fiber, 14. Formed on an oxide (not shown) on a major surface of the substrate is a series of electrode pairs, eg, 15 and 16, with one electrode from each pair on either side of the waveguide, 12. In this example, five pairs are shown, but any number of pairs can be formed.

As known in the art, each pair of electrodes constitutes an electrically tunable waveplate which can control the polarization of the light as it travels through the waveguide, 12. Since the substrate, 11, is photo-elastic, any stress will alter the index of refraction, and, therefore, a different dc bias will be applied to the pairs according to any localized stress in the substrate to compensate for this change in index of refraction. In order for the device to function optimally, it is important that the dc voltage for each pair be fairly constant, preferably within 2 volts. It is therefore important to reduce stresses as much as possible when packaging the device.

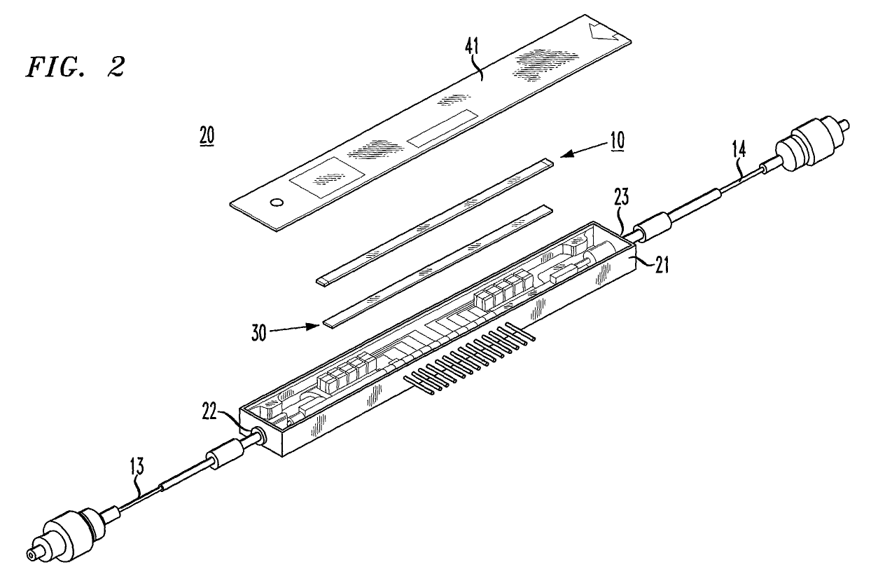

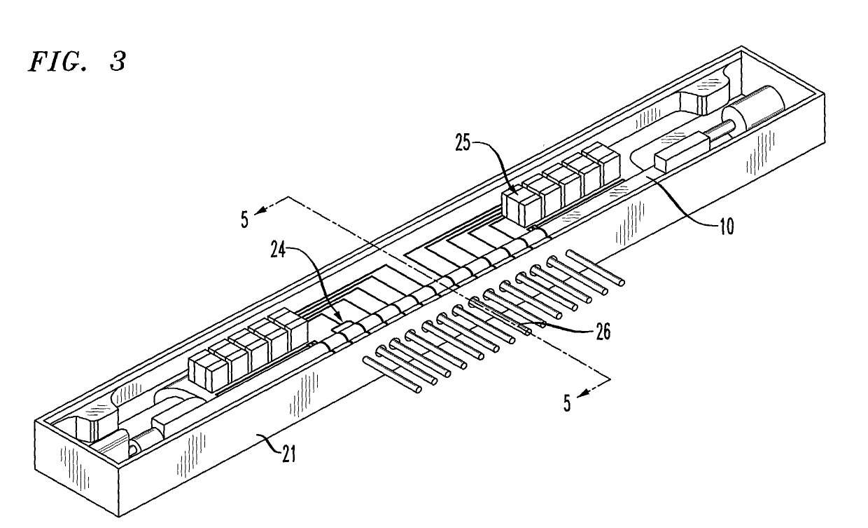

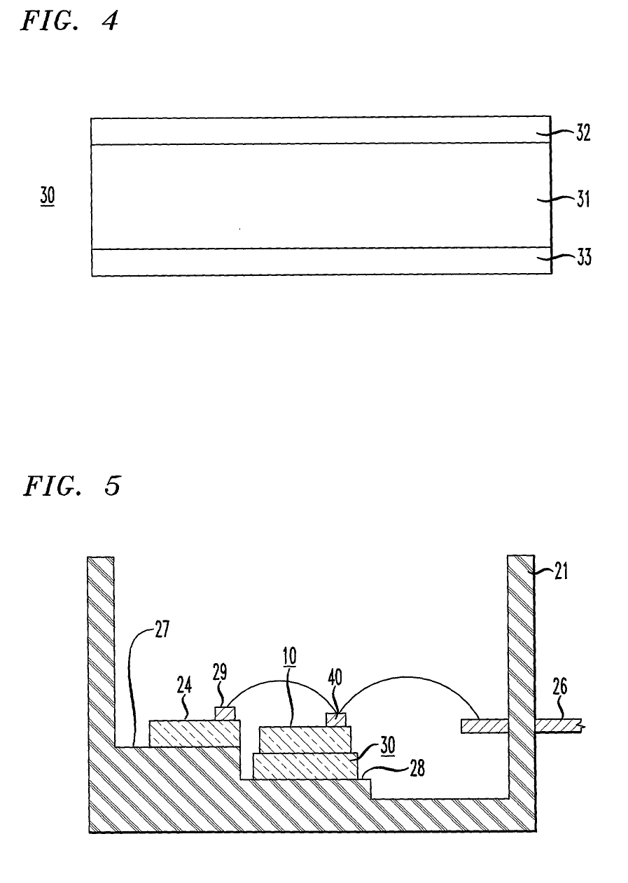

FIGS. 2-5 illustrate a package, 20, which results in reduced stress on the device. FIG. 2 illustrates assembly of the package with an exploded view, while FIG. 3 shows an enlarged view of a portion of an assembled package, and FIG. 5 shows a cross sectional view of the assembled package along 5-5 of FIG. 3.

The package includes a standard housing, 21, which is typically made of Kovar® or other metal or plastic material. An input port, 22, and an output port, 23, are provided in the housing for coupling the optical fibers, 13 and 14, to the device, 10. In addition to the device, 10, the package includes a ceramic substrate, 24, on which are mounted various devices, such as varistors, 25, which are electrically coupled to the device, 10. Electrical connection is provided to the electrodes, eg, 15 and 16, of the device, 10, by means of standard pins, eg, 26, which are wire-bonded to bonding pads, eg, 40, electrically connected to the electrodes. The pins extend through the housing, 21, and are coupled to an external bias (not shown).

In accordance with a feature of the invention, the device, 10, is bonded to the bottom of the housing, 21, utilizing a bonding medium, 30, which is shown in detail in the end view of FIG. 4. As illustrated in FIG. 4, the bonding medium, 30, includes a layer, 31, which is preferably a solid compliant material. In this example, the material was an acrylic foam with a thickness of approximately 0.025 inches. It is expected that other types of compliant material may be used in this application as long as they have a Shore A durometer hardness within the range 1-100, and preferably in the range 20-50. Thicknesses in the range 0.001 to 0.25 inches should be useful. Provided on both major surfaces of the layer, 31, are pressure sensitive adhesive layers, 32 and 33. In this example, the adhesive layers were acrylic with a thickness of 0.002 inches. In general other adhesive layers are expected to be beneficial as long as they provide good adhesion between the device and housing. Thicknesses in the range 0.0004 to 0.01 inches are expected to be beneficial. Generally, release liners (not shown) are provided on the adhesive layers, 32 and 33. These layers can be peeled off prior to the bonding process.

The above-described bonding medium is commercially available, and is sold by 3M under the designation VHB™ 4936 double coated acrylic foam tapes. It will be appreciated that, although this medium is currently preferred, other types of bonding media which are now or will be commercially available may be suitable.

In accordance with an embodiment of the invention, the package was assembled by first bonding the ceramic substrate, 24, to a pedestal, 27, formed in the bottom of housing, 21. Because stress is not a factor for such substrates, the ceramic can be bonded by using a standard liquid epoxy that is cured by heating at a temperature, for example, of 60 deg C. The bonding medium, 30, was then provided and preferably cut to a length that is approximately equal to the length of the device, 10. Useful results could be achieved with the medium, 30, equal to 10 to 200 percent of the device length. The medium was placed on a pedestal, 28, in the bottom of the housing, 21, next to the ceramic, 24. Pressure was applied to the medium, 30, to cause adherence between the adhesive layer, 33, and the housing.

As illustrated, for example, in FIGS. 2 and 5, the device 10 was aligned with the medium, 30, and placed on the adhesive layer, 32, of the medium, 30. Pressure was applied to the device, 10, to cause adherence to the adhesive layer, 32. Typically, the pressure would be approximately 15 psi, but pressures in the range of 0.01 to 200 psi would be useful. The device, 10, was thereby bonded to the housing, 21, with a minimum of stress. While in this embodiment, the bonding medium was first bonded to the housing, 21, and then to the device, 10, it could, alternatively, be first bonded to the device, 10, and then to the housing.

In further processing, the bonding pads, eg, 40, of the device, 10, and bonding pads, eg, 29, of the ceramic, 24, were electrically connected to appropriate pins, eg, 26, by standard ribbon bonding techniques. A cover, 41 of FIG. 2, was mounted on the housing, 21, to complete the package.

Packages produced by the above-described technique routinely exhibited a dc bias voltage variation along the device that was less than 2 volts. Similar packages employing liquid epoxy to bond the device, 10, to the housing, 21, typically exhibited a dc voltage variation as high as 12 volts.

While the invention has been described with reference to photo-elastic devices such as a lithium niobate polarization controller device, it should be realized that it could be used for other types of devices. For example, the technique could be suitable for lithium niobate modulators, especially those used in 40 Gbit/sec systems. Further, the material need not be lithium niobate, but could be any optical material where stress on the device can adversely affect performance, such as lithium tantalate, gallium arsenate, and indium phosphate.

It should also be appreciated that, although the embodiment described involves the use of pressure sensitive adhesive layers, it may be possible to utilize a compliant material which itself has adhesive properties and can be formed directly on the device or the housing.

Although the invention has been described with reference to exemplary embodiments, it is not limited to those embodiments. Rather, the appended claims should be construed to include other variants and embodiments of the invention which may be made by those skilled in the art without departing from the true spirit and scope of the present invention.

What is claimed:

1. A device package comprising:
a housing;
a photo-elastic device mounted within the housing; and
a bonding medium provided between the device and the housing, the bonding medium comprising a solid compliant material.

2. The package according to claim 1 wherein the solid compliant material comprises a material having a Shore A durometer hardness within the range 1-100.

3. The package according to claim 1 wherein the solid compliant material comprises a material having a Shore A durometer hardness within the range 20-50.

4. The package according to claim 1 wherein the solid compliant material comprises an acrylic foam.

5. The package according to claim 1 wherein the device comprises a substrate with a material selected from lithium niobate, lithium tantalate, gallium arsenate, or indium phosphate.

6. The package according to claim 1 wherein the bonding medium further comprises pressure sensitive adhesive layers formed on both major surfaces of the compliant material.

7. The package according to claim 1 wherein the device is a polarization controller.

8. The package according to claim 1 wherein the device is an optical modulator.

9. The package according to claim 7 wherein the device includes a plurality of pairs of electrodes, and the dc bias voltage difference along the device is no greater than 2 volts.

10. A device package comprising:
a housing;
an optical device comprising a lithium niobate substrate mounted within the housing; and
a bonding medium provided between the device and the housing, the bonding medium comprising an acrylic foam material with pressure sensitive adhesive layers formed on both major surfaces.

11. A method of fabricating a device package comprising the steps of:
bonding a photo-elastic device to a housing by providing therebetween a bonding medium comprising a flexible solid material; and
providing pressure to the device so that the device adheres to the housing.

12. The method according to claim 11 wherein the solid compliant material comprises a material having a Shore A durometer hardness within the range 1-100.

13. The method according to claim 11 wherein the solid compliant material comprises a material having a Shore A durometer hardness within the range 20-50.

14. The method according to claim 11 wherein the solid compliant material comprises an acrylic foam.

15. The method according to claim 11 wherein the device comprises a substrate with a material selected from lithium niobate, lithium tantalate, gallium arsenate, or indium phosphate.

16. The method according to claim 11 wherein the bonding medium further comprises pressure sensitive adhesive layers formed on both major surfaces of the compliant material.

17. The method according to claim 11 wherein the device is a polarization controller.

18. The method according to claim 11 wherein the device is an optical modulator.

19. The method according to claim 11 wherein the applied pressure is within the range 0.01 to 200 psi.

20. A method of fabricating a device package comprising the steps of:
bonding an optical device comprising a lithium niobate substrate to a housing by providing therebetween a bonding medium comprising an acrylic foam material with pressure sensitive adhesive layers formed on both major surfaces; and
providing pressure to the device so that the device adheres to the housing.
